(19) United States
(12) Patent Application Publication
(10) Pub. No.: US 2012/0163218 A1
(43) Pub. Date: Jun. 28, 2012

(54) APPARATUS AND METHOD FOR MULTIPLE ACCESSES BASED ON RESOURCE CONTENTION USING DIRECTIONAL ANTENNA

(75) Inventors: Yong Sun KIM, Chungcheongnam-do (KR); Mee Joung Kim, Seoul (KR); Woo Yong Lee, Daejeon (KR)

(73) Assignee: ELECTRONICS AND TELECOMMUNICATIONS RESEARCH INSTITUTE, Daejeon-city (KR)

(21) Appl. No.: 13/334,097

(22) Filed: Dec. 22, 2011

(30) Foreign Application Priority Data
Dec. 23, 2010 (KR) 10-2010-0133542

(51) Int. Cl. H04W 24/00; H04W 72/04; H04L 12/26

(52) U.S. Cl. 370/252

(57) ABSTRACT

Provided is an apparatus and method for spatial reuse of resources using a directional antenna based on a resource contention in a wireless network. An apparatus for multiple accesses based on a resource contention using a directional antenna may use a resource contention period efficiently in a medium access control (MAC) by calculating an optimal value of an objective function for a delay time and a throughput.

### CROSS-REFERENCE TO RELATED APPLICATION

This application claims the benefit of Korean Patent Application No. 10-2010-0133542, filed on Dec. 23, 2010, in the Korean Intellectual Property Office, the disclosure of which is incorporated herein by reference.

### BACKGROUND

1. Field of the Invention

The present invention relates to an apparatus and method for spatial reuse of resources using a directional antenna based on resource contention in a wireless network.

2. Description of the Related Art

A millimeter wave band corresponding to a range from 57 to 66 gigahertz (GHz) may ease a worldwide shortage of frequency resources. In particular, an unlicensed band, allocated to be used as the millimeter wave band, is commanding attention. For example, currently, Korea and North America including the United States (U.S.), Canada, and the like may allocate, as a usage band, frequencies in a bandwidth in a range of 57 to 64 GHz (which corresponds to a 7 GHz bandwidth), and Japan may allocate, as a usage band, frequencies in a bandwidth in a range of 59 to 66 GHz (which corresponds to a 7 GHz bandwidth). Further, the U.S., Korea, and Japan have prepared technical standards so as to lead in the development of a fundamental technology and vitalization of this industry.

Standardization activity for the millimeter wave band may include European Telecommunications Standards Institute (ETSI)/Broadband Radio Access Network (BRAN) associated with a wireless local area network (WLAN) application, ISO21216 associated with de-facto international standard, Intelligent Transportation System (ITS) communication applications, and the like. Further, a Wireless High Definition (WiHD) consortium, European Computer Manufacturers Association (ECMA) international, and the like associated with a Wireless Personal Area Network (WPAN) application may be included.

A millimeter wave has unique properties of a short wavelength, a high frequency, a wideband, and a large amount of exchange with atmospheric components. The millimeter wave has merits of a high data transmission rate obtained by using an ultra wideband, a high resistance against interference in proximity due to a high straightness, an excellent security, a ease of reusing a frequency, and the like. A short wavelength of the millimeter wave may enable various devices to be miniaturized and weigh less.

In contrast, the millimeter wave has demerits of a short length of propagation due to absorption by an oxygen molecule and due to a phenomenon of rain attenuation, and a line of sight may be secured due to a characteristic of straightness.

Utilization of the millimeter wave may increase as various wireless applications, for example, a wireless High Definition Multimedia Interface (HDMI), a wireless universal serial bus (USB), an IPTV/VoD, three-dimensional (3D) gaming, an intelligent transportation system using a relatively high transmission rate.

### SUMMARY

An aspect of the present invention provides an apparatus and method for minimizing a communication delay time and efficiently using resources by reusing a space using a directional antenna in a resource contention period of a wireless network.

Another aspect of the present invention also provides an apparatus and method for minimizing a communication delay experienced by a user by efficiently allocating resources in a contention based transmission period of a medium access control (MAC).

Still another aspect of the present invention also provides an apparatus and method for efficiently using resources by reducing collisions in a contention based transmission period of a MAC.

According to an aspect of the present invention, there is provided an apparatus for multiple accesses based on a resource contention using a directional antenna in the resource contention of a wireless network using the directional antenna, the apparatus including a probability calculator to determine a waiting time for a data transmission based on a total number of adjacent transmission devices N affecting a target transmission device and a target reception device, an initial value of a contention window updated according to a predetermined requirement, and a maximum value of the contention window, and to calculate a probability for determining a value of a back-off counter based on the waiting time and the total number N, a back-off counter determining unit to determine the value of the back-off counter based on the probability, a data transmitter to control the back-off counter based on a channel state, and to transmit data in response to a value of the back-off counter becoming “0,” and a maximum throughput and minimum delay time calculator to calculate a throughput and a delay time used for transmitting the data, and to extract a first contention window initial value corresponding to a minimum delay time in the delay time and a second contention window initial value corresponding to a maximum throughput in the throughput when the initial value of the contention window has a predetermined default value.

The apparatus may further include a setting unit to set the initial value of the contention window to “1,” and to set the maximum value of the contention window to the predetermined default value, an information collector to collect information about the adjacent transmission devices affecting the resource contention using neighbor discovery information and information from a piconet coordinator, an area determining unit to determine a sensing region and an exclusive region based on the information about the adjacent transmission devices, and a calculator to calculate the total number N based on the sensing region and the exclusive region.

The sensing region may correspond to a region for sensing a data transmission of a first transmission device when observed from the target transmission device, and the exclusive region may correspond to a region for receiving data from the target transmission device by not sensing a data transmission of a second transmission device when observed from the target reception device.

The area determining unit may determine the sensing region and the exclusive region based on a distance between the target transmission device and the target reception device calculated using an antenna gain of the target transmission device, an antenna gain of the target reception device, a constant according to a propagation distance, a path loss exponent determined by a propagation environment, and transmission power of the target transmission device, and based on locations of the target transmission device, the target reception device, and the adjacent transmission devices.

The probability calculator may include a waiting time determining unit to determine, as the waiting time, the initial value when the total number N is less than or equal to the initial value of the contention window, the total number N when the total number N is greater than the initial value and is less than or equal to the predetermined default value, and the predetermined default value when the total number N is greater than the predetermined default value.

The probability calculator may calculate a probability for determining the value of the back-off counter based on the initial value in response to the initial value being determined as the waiting time, a probability for determining the, value of the back-off counter based on the total number N in response to the total number N being determined as the waiting time, and a probability for determining the value of the back-off counter based on the total number N and the predetermined default value in response to the predetermined default value determined as the waiting time.

The back-off counter determining unit may determine the value of the back-off counter according to a first probability calculated based on the total number N or a second probability calculated based on the predetermined default value randomly applied for the target transmission device and the adjacent transmission devices in response to the predetermined default value being determined as the waiting time.

The data transmitter may detect the channel state for each starting point in time of a time slot corresponding to the back-off counter, and may reduce the back-off counter by a single time slot in response to detection of the channel state as an idle state.

The maximum throughput and minimum delay time calculator may increase the initial value of the contention window by “1” until the initial value reaches the predetermined default value each time the delay time and the throughput are calculated.

The maximum throughput and minimum delay time calculator may calculate the delay time based on a time interval from point in time of traffic occurring before transmitting of the traffic starts, and based on a point in time at which transmitting of the traffic is completed, and the throughput based on a first time interval used for transmitting the traffic and an amount of traffic transmitted during the first time interval.

According to another aspect of the present invention, there is provided a method for multiple accesses based on a resource contention using a directional antenna in the resource contention of a wireless network using the directional antenna, the method including setting an initial value of a contention window to “1,” and setting a maximum value of the contention window to a predetermined default value, calculating a total number of adjacent transmission devices N affecting a target transmission device and a target reception device based on a sensing region and an exclusive region, determining a waiting time for a data transmission based on the total number N, the initial value of the contention window updated according to a predetermined requirement, and a maximum value of the contention window, calculating a probability for determining a value of a back-off counter based on the waiting time and the total number N, determining the value of the back-off counter based on the probability, detecting a channel state for each starting point in time of a time slot corresponding to the back-off counter, controlling the back-off counter based on the channel state, and transmitting data in response to a value of the back-off counter becoming “0,” calculating a throughput and a delay time used for transmitting the data, and extracting a first contention window initial value corresponding to a minimum delay time in the delay time and a second contention window initial value corresponding to a maximum throughput in the throughput when the initial value of the contention window has the predetermined default value.

The method may further include collecting information about the adjacent transmission devices affecting the resource contention using neighbor discovery information and information from a piconet coordinator, and determining the sensing region and the exclusive region based on the information about the adjacent transmission devices.

The determining of the waiting time may include determining, as the waiting time, the initial value when the total number N is less than or equal to the initial value of the contention window, the total number N when the total number N is greater than the initial value and is less than or equal to the predetermined default value, and the predetermined default value when the total number N is greater than the predetermined default value.

The transmitting may include reducing the back-off counter by a single time slot in response to detection of the channel state as an idle state.

The method may further include determining whether the initial value of the contention window has the same value as the predetermined default value after calculating the delay time and the throughput, and increasing the initial value of the contention window by “1” when the initial value of the contention window is not equal to the predetermined default value.

According to embodiments of the present invention, it is possible to minimize a communication delay time and efficiently use resources by reusing a space using a directional antenna in a resource contention period of a wireless network.

According to embodiments of the present invention, it is possible to minimize a communication delay experienced by a user by efficiently allocating resources in a contention based transmission period of a MAC.

According to embodiments of the present invention, it is possible to efficiently use resources by reducing collisions in a contention based transmission period of a MAC.

According to embodiments of the present invention, it is possible to efficiently use a resource contention period in a MAC by calculating an optimal value of an objective function for a delay time and a throughput.

According to embodiments of the present invention, it is possible to apply the present invention to a resource contention based period of any wireless network using a directional antenna.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an apparatus for multiple accesses based on a resource contention using a directional antenna according to embodiments of the present invention;

FIGS. 2A and 2B are diagrams illustrating an operation of determining a back-off counter according to embodiments of the present invention;

FIG. 3 is a diagram illustrating a superframe structure of IEEE 802.15.3c to which the present invention is applied according to embodiments of the present invention;

FIGS. 4A, 4B, 4C, and 4D are diagrams illustrating a sensing region and an exclusive region according to embodiments of the present invention;

FIG. 5 is a flowchart illustrating a method for multiple accesses based on a resource contention using a directional antenna according to embodiments of the present invention;

FIG. 6 is a flowchart illustrating a method of determining a waiting time and a probability for determining a value of a back-off counter according to operation 507 of FIG. 5; and

FIG. 7 is a flowchart illustrating a method of transmitting data according to operation 511 of FIG. 5.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

To handle a defect of a millimeter wave, a directional antenna having a relatively high gain in a physical layer may be used. When the directional antenna is used, transmission energy may be radiated in a desired direction and thus, a propagation distance may increase, and a high gain may be obtained. When a relatively narrow antenna beam is used, a space may be reused, which may enable several users in the same area to simultaneously communicate and thus, a data capacity may be increased.

Research on a millimeter wave based on the directional antenna is being conducted, and an issue of allocating resources in a medium access control (MAC) of a wireless personal area network (WPAN) is commanding attention. In a period of contentiously obtaining resources of a wireless network, a protocol referred to as a Carrier Sense Multiple Access/Collision Avoidance (CSMA/CA) may be performed. The CSMA/CA may enhance an efficiency of using resources by dispersing users who desire to use the resources simultaneously.

The present invention relates to a method of using resources in a resource contention efficiently based data transmission period using a directional antenna in a wireless network, and aims at searching for an optimal value of a contention window that minimizes a throughput or a transmission delay. The present invention may be applied to any wireless network using a directional antenna. For example, the present invention may be applied to a contention algorithm in a contention access period (CAP) in an IEEE 802.15.3c MAC based on a quasi-omni mode in a millimeter wave WPAN. Hereinafter, for convenience of description, the present invention will be described using in terms of the recently standardized IEEE 802.15.3c standard.

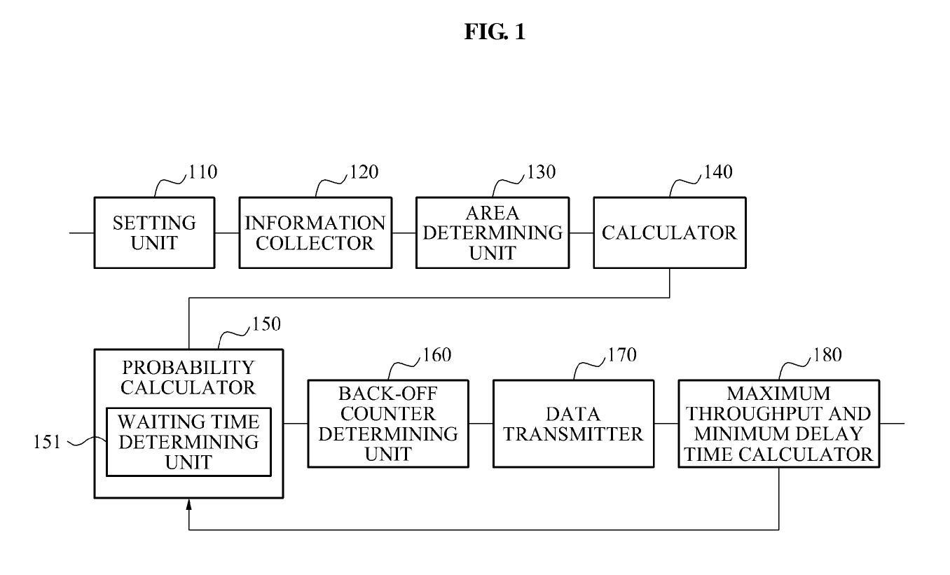

FIG. 1 is a diagram illustrating an apparatus for multiple accesses based on a resource contention using a directional antenna according to embodiments of the present invention.

Referring to FIG. 1, an apparatus for multiple accesses based on a resource contention using a directional antenna according to embodiments of the present invention may include a setting unit 110, an information collector 120, an area determining unit 130, a calculator 140, a probability calculator 150, a back-off counter determining unit 160, a data transmitter 170, and a maximum throughput and minimum delay time calculator 180.

The setting unit 110 may set an initial value CWᵢₙᵢ of a contention window to “1,” and may set a maximum value CWₘₐₓ of the contention window to a predetermined default value. The contention window may correspond to a time interval for waiting so as to avoid a collision before transmitting data through a channel.

The information collector 120 may collect information about adjacent transmission devices affecting a resource contention using neighbor discovery information and information from a piconet coordinator. The adjacent transmission devices affecting a resource contention may be referred to as an interferer.

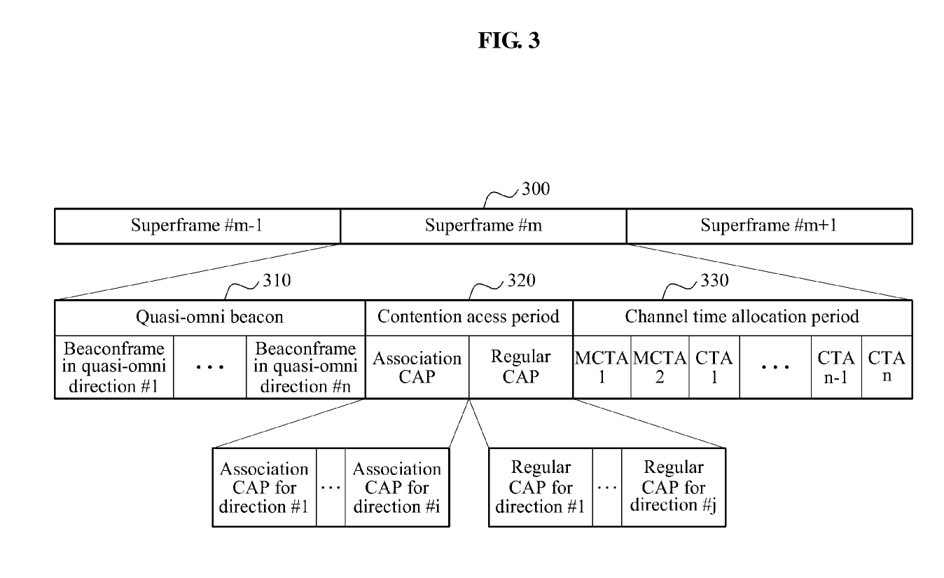

A neighbor discovery may correspond to an operation performed in a WPAN using a directional antenna. The neighbor discovery may be determined in all devices included in a piconet. Each device included in the piconet may obtain neighbor, discovery information of a neighbor device isolated by one hop through the neighbor discovery. The neighbor discovery information may include an address of each device included in the piconet, an index of a transmission beam sector, and an antenna direction. The neighbor discovery will be further described with reference to FIG. 3.

The piconet coordinator may collect information acquired through the neighbor discovery from each device included in the piconet. The piconet coordinator may allocate a channel of the piconet, and may control traffic loads.

The information collector 120 may collect information about the adjacent transmission devices affecting a target transmission device and a target reception device. Here, the target transmission device may correspond to a transmission device that waits for a channel to be allocated to transmit data, and the target reception device may correspond to a reception device that receives data transmitted from the target transmission device. The adjacent transmission devices may correspond to devices that affect a data transmission of the target transmission device and a data reception of the target reception device.

The area determining unit 130 may determine a sensing region and an exclusive region based on the information about the adjacent transmission devices. Information about the sensing region and the exclusive region may be stored as the information about the adjacent transmission devices in the piconet coordinator.

The sensing region may correspond to a region for sensing data transmission of a first transmission device when observed from the target transmission device. The first transmission device may correspond to at least one of the adjacent transmission devices. The sensing region may refer to a region for sensing data transmission of the adjacent transmission devices.

The exclusive region may correspond to a region for receiving data from the target transmission device by not sensing a data transmission of a second transmission device when observed from the target reception device. The second transmission device may correspond to at least one of the adjacent transmission devices, and may correspond to a transmission device not affecting a data reception of the target reception device. The exclusive region may correspond to a region in which data may be exchanged between the target transmission device and the target reception device without interference from the adjacent transmission devices.

In general, the exclusive region may be smaller than the sensing region.

The area determining unit 130 may determine the sensing region and the exclusive region based on based on a distance between the target transmission device and the target reception device, and based on locations of the target transmission device, the target reception device, and the adjacent transmission devices.

The distance between the target transmission device and the target reception device may be calculated using an antenna gain of the target transmission device, an antenna gain of the target reception device, a constant according to a propagation distance, a path loss exponent determined by a propagation environment, and transmission power of the target transmission device. The distance between the target transmission device and the target reception device denoted by r_{j,i} may be calculated based on Equation 1.

$${r}_{j , i} = {( \frac{κ {G}_{T} ( j ) {G}_{R} ( i ) {P}_{T} ( j )}{{N}_{0} W} )}^{1 / α} \qquad [ Equation 1 ]$$

In Equation 1, κ denotes a constant according to a propagation distance, G_{T}(j) denotes an antenna gain of the target reception device of a j flow, G_{R}(i) denotes an antenna gain of the target reception device of an i flow, P_{T}(j) denotes transmission power of the target transmission device of the j flow, α denotes a path loss exponent determined by a propagation environment. N₀ denotes the one-sided spectral density of white Gaussian noise, and W denotes a channel bandwidth.

The calculator 140 may calculate a total number of adjacent transmission devices N affecting the target transmission device and the target reception device based on the sensing region and the exclusive region. The sensing region and the exclusive region may be stored as information about the adjacent transmission devices.

The calculator 140 may calculate, based on the information about the adjacent transmission devices, a number of adjacent transmission devices N_{TX} affecting a data transmission of the target transmission device and a number of adjacent transmission devices N_{RX} affecting a data reception of the target reception device. The calculator 140 may calculate a number of adjacent transmission devices N_{TR} affecting both of the target transmission device and the target reception device. Thus, calculator 140 may calculate the total number N to be N_{TX}+N_{RX}−N_{TR}.

The calculator 140 may calculate the total number N based on probability when the target transmission device, the target reception device, and the adjacent transmission devices are presumed to be uniformly dispersed in a single piconet. Since the piconet coordinator stores information about all devices in the piconet, the calculator 140 may calculate the total number N based on the information.

The probability calculator 150 may determine a waiting time W₀ for a data transmission based on a total number of adjacent transmission devices N affecting a target transmission device and a target reception device, an initial value CWᵢₙᵢ of a contention window updated according to a predetermined requirement, and a maximum value CWₘₐₓ of the contention window. The predetermined requirement may correspond to a case in which the initial value CWᵢₙᵢ of a contention window is not equal to the predetermined default value. Here, the initial value CWᵢₙᵢ of the contention window may increase by “1” until the initial value CWᵢₙᵢ reaches the same value as the predetermined default value after a delay time and a throughput are calculated.

Here, the waiting time W₀ may correspond to a size of the contention window. The size of the contention window may be determined based on the total number N, the initial value CWᵢₙᵢ of the contention window updated according to a predetermined requirement, and the maximum value CWₘₐₓ of the contention window.

The probability calculator 150 may include a waiting time determining unit 151.

The waiting time determining unit 151 may determine, as the waiting time W₀, the initial value CWᵢₙᵢ of the contention window when the total number N is less than or equal to the initial value CWᵢₙᵢ of the contention window. In this case, since a number of the adjacent transmission devices is relatively small, setting the waiting time W₀ to the predetermined default value may increase the waiting time W₀ wastefully before transmitting data. Thus, the waiting time determining unit 151 may determine the initial value CWᵢₙᵢ as the waiting time W₀.

The waiting time determining unit 151 may determine, as the waiting time W₀, the total number N when the total number N is greater than the initial value CWᵢₙᵢ and is less than or equal to the predetermined default value. The maximum value CWₘₐₓ of the contention window may be set to the predetermined default value. Here, the predetermined default value may be set differently depending on a standard to be applied. The predetermined default value may be 8 according to IEEE 802.3. In this instance, since a number of the adjacent transmission devices is relatively small, setting the waiting time W₀ to the predetermined default value may increase the waiting time W₀ wastefully before transmitting data. Thus, the waiting time determining unit 151 may determine the total number N as the waiting time W₀.

The waiting time determining unit 151 may determine, as the waiting time W₀, the predetermined default value when the total number N is greater than the predetermined default value.

The probability calculator 150 may calculate a probability for determining a value of a back-off counter based on the waiting time W₀ and the total number N.

The probability calculator 150 may calculate the probability for determining the value of the back-off counter based on the initial value CWᵢₙᵢ of the contention window in response to the waiting time W₀ being determined the initial value CWᵢₙᵢ of the contention window. In particular, the probability calculator 150 may calculate the probability for determining the value of the back-off counter to be 1/(CWᵢₙᵢ).

The probability calculator 150 may calculate the probability for determining the value of the back-off counter based on the total number N in response to the waiting time W₀ being determined the total number N. In particular, the probability calculator 150 may calculate the probability for determining the value of the back-off counter to be 1/(N).

The probability calculator 150 may calculate the probability for determining the value of the back-off counter based on the total number N and the predetermined default value in response to the waiting time W₀ being determined the predetermined default value. In this instance, the probability calculator 150 may calculate a first probability α to be 1/(N) and a second probability β to be 1−(W₀−1)/(N) that may be applied randomly for the target transmission device and adjacent transmission devices.

The back-off counter determining unit 160 may determine the value of the back-off counter based on the probability for determining the value of the back-off counter.

The back-off counter may refer to a number of times for detecting a channel to avoid a collision between the target transmission device and adjacent transmission devices before transmitting data through the channel. A time period during which the target transmission device waits to transmit data may depend on a channel state and thus, a time period for waiting before transmitting data may be equal to a waiting time when a channel is detected to be idle, for each point in time at which detection takes place. However, the time period for waiting before transmitting data may be greater than the waiting time when the channel is not idle at any point in time at which detection takes place.

The back-off counter determining unit 160 may determine the value of the back-off counter based on a probability 1/(CWᵢₙᵢ) for the target transmission device and the adjacent transmission devices in response to the waiting time W₀ being determined to be the initial value CWᵢₙᵢ of the contention window.

The back-off counter determining unit 160 may determine the value of the back-off counter based on a probability 1/(N) for the target transmission device and the adjacent transmission devices in response to the waiting time W₀ being determined the total number N.

The back-off counter determining unit 160 may determine the value of the back-off counter according to a first probability a calculated based on the total number N or a second probability β calculated based on the predetermined default value applied randomly for the target transmission device and the adjacent transmission devices in response to the predetermined default value being determined as the waiting time.

The back-off counter determining unit 160 may randomly apply the first probability α to the target transmission device and the adjacent transmission devices to determine the back-off counter having a value from “0” to W₀−2. The back-off counter determining unit 160 may apply the second probability β randomly to the target transmission device and the adjacent transmission devices to determine the back-off counter having a value W₀−1. The back-off counter may have a value of “0,” “1,” . . . , W₀−2, W₀−1.

The back-off counter determining unit 160 may reduce a probability of a collision by causing a collision to occur between the target transmission device and the adjacent transmission device in a single state of W₀−1, in terms of a probability. The back-off counter determining unit 160 may enable effective use of a channel when compared to a general CSMA/CA by concentrating a point in time at which a collision occurs on a single state in a case in which a great number of devices are included in a piconet.

The back-off counter determining unit 160 may minimize a transmission delay by causing a collision to occur between the target transmission device and the adjacent transmission device in a final state W₀−1. In an immediate-ACK (imm-ACK) mode for a retransmission, when transmission devices for which the back-off counter is determined to be in a state of W₀−1 performs a resource contention for a retransmission, transmission devices for which the back-off counter is determined to be in a state of “0,” “1,” . . . , W₀−2 may already complete transmission. Thus, the back-off counter determining unit 160 may minimize a transmission delay by allowing a resource contention between the transmission devices for which the back-off counter is determined to be in a state of W₀−1.

Accordingly, the transmission devices for which the back-off counter is determined to be in a state of W₀−1 may perform a resource contention in a retransmission and thus, a number of devices performing a contention may decrease, and an entire transmission time may be reduced.

The data transmitter 170 may control the back-off counter based on a channel state, and to transmit data in response to a value of the back-off counter becoming “0.” The data transmitter 170 may detect the channel state for each starting point in time of a time slot corresponding to the back-off counter. The data transmitter 170 may reduce the back-off counter by a single time slot in response to detection of the channel state in an idle state.

The maximum throughput and minimum delay time calculator 180 may calculate a throughput and a delay time used for transmitting the data. The delay time may include a queuing delay (referred to as W) corresponding to a time interval from point in time of traffic occurring before transmitting of the traffic starts and a service time (referred to as S) corresponding to a point in time at which transmitting of the traffic is completed. The delay time may be expressed by minE(D)=min(W+S). The throughput may be calculated as a ratio of an amount of traffic, transmitted during a first time interval used for transmitting the traffic, to the first time interval. The throughput may be expressed by an objective function

$$maxTh = max ( \frac{amount of traffic transmitted during a time interval}{the time interval used for transmitting the traffic} ) .$$

The maximum throughput and minimum delay time calculator 180 may extract a first contention window initial value corresponding to a minimum delay time in the delay time and a second contention window initial value corresponding to a maximum throughput in the throughput when the initial value CWᵢₙᵢ of the contention window has a predetermined default value. The first contention window initial value may refer to a time period for waiting before transmitting data and corresponding to the minimum delay time, and the second contention window initial value may refer to a time period for waiting before transmitting data and corresponding to the maximum throughput.

The maximum throughput and minimum delay time calculator 180 may determine the first contention window initial value as an optimized contention window corresponding to the minimum delay time, and may determine, the second contention window initial value as an optimized contention window corresponding to the maximum throughput.

The maximum throughput and minimum delay time calculator 180 may increase the initial value of the contention window by “1” until the initial value reaches the predetermined default value each time the delay time and the throughput are calculated. The maximum throughput and minimum delay time calculator 180 may calculate the delay time and the throughput until the initial value of the contention window reaches a maximum value.

The maximum throughput and minimum delay time calculator 180 may calculate the delay time based on a time interval from point in time at which traffic occurs before transmitting of the traffic starts, and based on a point in time at which transmitting of the traffic is completed. The maximum throughput and minimum delay time calculator 180 may calculate the throughput based on a first time interval used for transmitting the traffic and an amount of traffic transmitted during the first time interval.

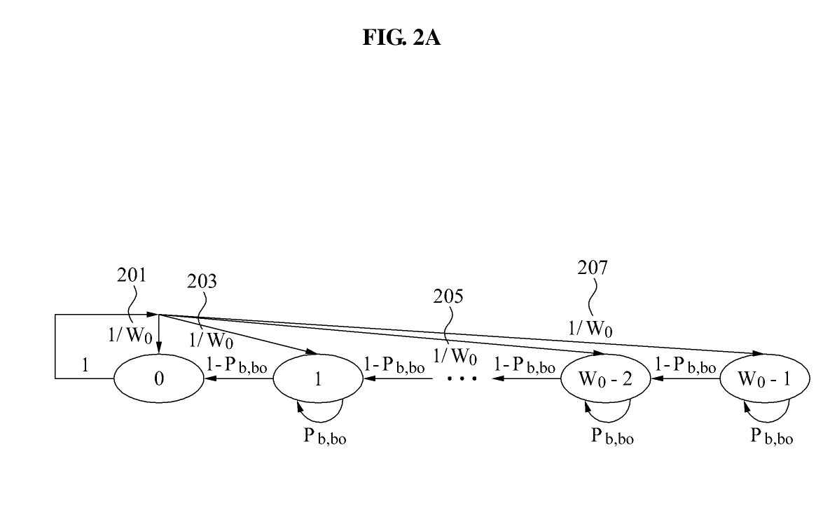

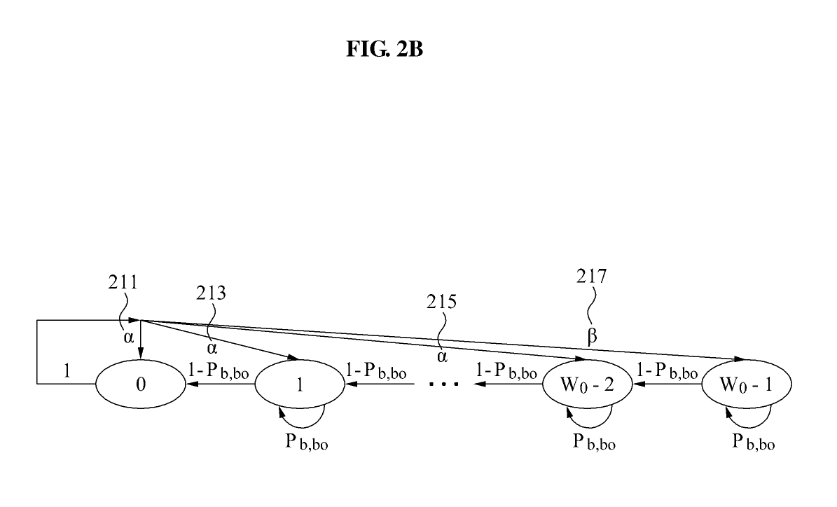

FIGS. 2A and 2B are diagrams illustrating an operation of determining a back-off counter according to embodiments of the present invention.

FIGS. 2A and 2B illustrate a CSMA/CA scheme in a case of not considering an acknowledgement (ACK) signal and a CSMA/CA scheme in a saturation state, respectively.

In a scheme of FIG. 2A, to perform a contention for using resources, a target transmission device and an adjacent transmission device may wait for a back-off counter determined to have the same probability, and then participate in the contention. In a scheme of FIG. 2B, the target transmission device and the adjacent transmission device may wait for a back-off counter determined to perform a contention for using resources, and then participate in the contention. However, the back-off counter may not be determined to have the same probability. In this instance, the probability may be determined to minimize a collision and a transmission delay and to maximize a throughput.

In the scheme of FIG. 2A, a back-off counter may have a value from “0” to W₀−1. A probability that the back-off counter has a value from “0” to W₀−1 may be the same, which may be 1/W₀ for each case 201, 203, 205, and 207. P_{b,bo} corresponds to a probability when a channel state is busy. When the channel state is busy, the back-off counter may not decrease. In response to the channel state being in an idle state corresponding to 1-P_{b,bo}, the back-off counter may decrease by “1.” In response to a value of the back-off counter being “0,” the target transmission device may transmit data.

In the scheme of FIG. 2B, a probability a that the back-off counter has a value from “0” to W₀−2 corresponding to cases 211, 213, and 215 may be different from a probability β that the back-off counter has a value of W₀−1 corresponding to a case 217. That is, the adjacent transmission device affecting the target transmission device and a data transmission of the target transmission device may determine the back-off counter by applying the probability α randomly, and may determine the back-off counter having W₀−1 by applying the probability β randomly. Accordingly, the scheme of FIG. 2B may reduce a probability of a collision by causing a collision to occur between the target transmission device and the adjacent transmission device in a single state of W₀−1 in terms of a probability. The scheme of FIG. 2B may enable effective use of a channel when compared with a general CSMA/CA by concentrating a point in time at which a collision occurs on a single state for a case in which a great number of devices are included in a piconet. The scheme of FIG. 2B may minimize a transmission delay by causing a back-off counter of the target transmission device and the adjacent transmission device to have a value of W₀−1.

FIG. 3 is a diagram illustrating a superframe structure of IEEE 802.15.3c to which the present invention is applied according to embodiments of the present invention.

A superframe may include a beacon period 310, a contention access period (CAP) 320, and a channel time allocation period (CTAP) 330. The CTAP 330 may include a management CTA (MCTA) period in which communication is performed between a PNC and devices included in the PNC, and may include a CTA period in which communication is performed between devices included in the PNC.

A fundamental topology of an 802.15.3c WPAN may correspond to a piconet. The piconet may include a PNC corresponding to a central device and several slave devices within a transmission coverage area of the PNC, and any device may function as the PNC. Each device may perform communication using a directional antenna. The PNC may collect information about the piconet, allocate a channel to each device based on the information, and control traffic loads.

In piconet, the PNC may collect information through a neighbor discovery by each device. An operation of the neighbor discovery may correspond to a basic and significant operation in a WPAN using the directional antenna.

Each device may investigate information about a neighbor isolated by one hop through the neighbor discovery. Each device may transmit a self-advertising packet reporting an existence of each device in all beam sectors continuously, and a neighboring device receiving the self-advertising packet may respond to the self-advertising packet, thereby performing the neighbor discovery. The self-advertising packet may include an address of a transmission device, and an index of a transmission beam sector, and the like.

In response to a predetermined device receiving a self-advertising packet, of a neighboring device, that reports an existence of the neighboring device, the predetermined device may store an address of the transmission device, information about an antenna direction of the transmission device, and the like in a neighbor information list, and may send a response message to the transmission device. The response message may include an address of a reception device and an index of a beam sector transmitting the response message.

An entire operation of the neighbor discovery may be performed in a quasi-omni mode. The neighbor discovery may be performed periodically to maintain and update information of the neighboring device, and an operation of the neighbor discovery may generally be performed in a CAP.

Thus, an apparatus for multiple accesses based on a resource contention using a directional antenna according to embodiments of the present invention may be applied to a resource contention operation in the CAP.

In response to a predetermined device detecting a neighboring device from several beam sectors, the predetermined device may store a sector having a greatest signal strength among the several beam sectors in an information list for the neighboring device to communicate. Stored information may be sent to the PNC, and the PNC may manage a piconet topology based on information collected from each device, and may perform a transmission scheduling.

The PNC may manage an admission table to store a scheduled channel access requirement. An identification (ID) of a device requesting a channel, an ID of a device corresponding to a target for the device requesting a channel, and ID of a listed CTA block, an access time of an allocated channel, and the like may be stored in the admission table. The admission table may periodically be broadcasted for each direction using the directional antenna in a beacon period, thereby being transmitted to all devices in the piconet.

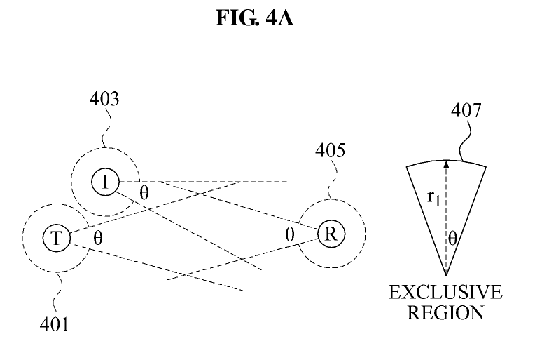

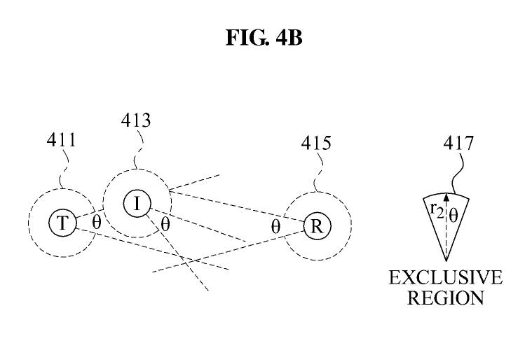

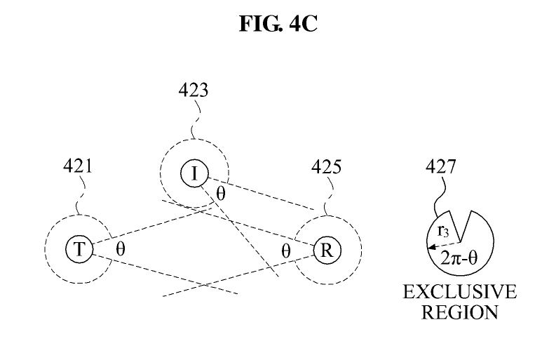

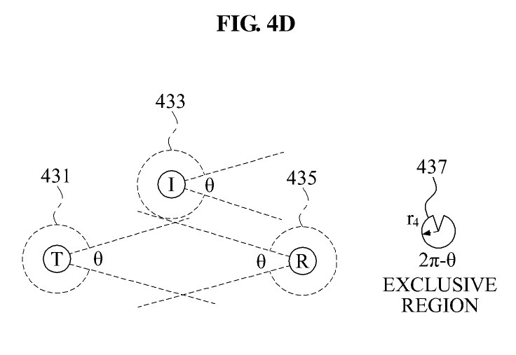

FIGS. 4A, 4B, 4C, and 4D are diagrams illustrating a sensing region and an exclusive region according to embodiments of the present invention.

When a directional antenna is used, an apparatus for multiple accesses based on a resource contention using a directional antenna according to embodiments of the present invention may determine a flow that is simultaneously transmissible based on a sensing region and an exclusive region.

The sensing region may refer to a region for detecting a data transmission of adjacent transmission devices. The exclusive region may refer to a region in which a transmission device and a reception device of a single flow may communicate with each other without being interfered by the adjacent transmission devices. When the directional antenna is used, a number of the adjacent transmission devices affecting a resource contention of a single transmission device may be less in comparison to a case of using an omnidirectional antenna and thus, W₀ corresponding to a value of a contention window may be determined based on the number of the adjacent transmission devices affecting the resource contention.

A directional antenna model may include a flat-top model and a three-dimensional (3D) cone plus sphere model. FIG. 4A relates to a two-dimensional (2D) cone plus circle model. In a cone plus sphere model, an antenna gain may include a mainlobe having a beam width θ and a sidelobe having a beam width of 2π−θ.

FIGS. 4A, 4B, 4C, and 4D illustrate the cone plus sphere model and an exclusive region corresponding to a region in which a pair of a target transmission device and a target reception device may communicate with each other according to locations of the pair of the target transmission device and the target reception device and an adjacent transmission device of another flow.

FIG. 4A illustrates a target transmission device 410 and a target reception device 405 that are located in the same flow, and each of an adjacent transmission device 403 of another flow and the target reception device 405 is located at each radiation angle. In this instance, an exclusive region 407 may have a beam width θ and a radius r₁.

FIG. 4B illustrates a target transmission device 411 and a target reception device 415 that are located in the same flow, and an adjacent transmission device 413 of another flow is located within a radiation angle of the target reception device 415. In this instance, an exclusive region 417 may have a beam width θ and a radius r₂.

FIG. 4C illustrates a target transmission device 421 and a target reception device 425 that are located in the same flow, and the target reception device 425 is located within a radiation angle of an adjacent transmission device 423 of another flow. In this instance, an exclusive region 427 may have a beam width 2π−θ and a radius r₃.

FIG. 4D illustrates a target transmission device 431 and a target reception device 435 that are located in the same flow, and each of an adjacent transmission device 433 of another flow and the target reception device 435 is not located within each radiation angle. In this instance, an exclusive region 437 may have a beam width 2π−θ and a radius r₄.

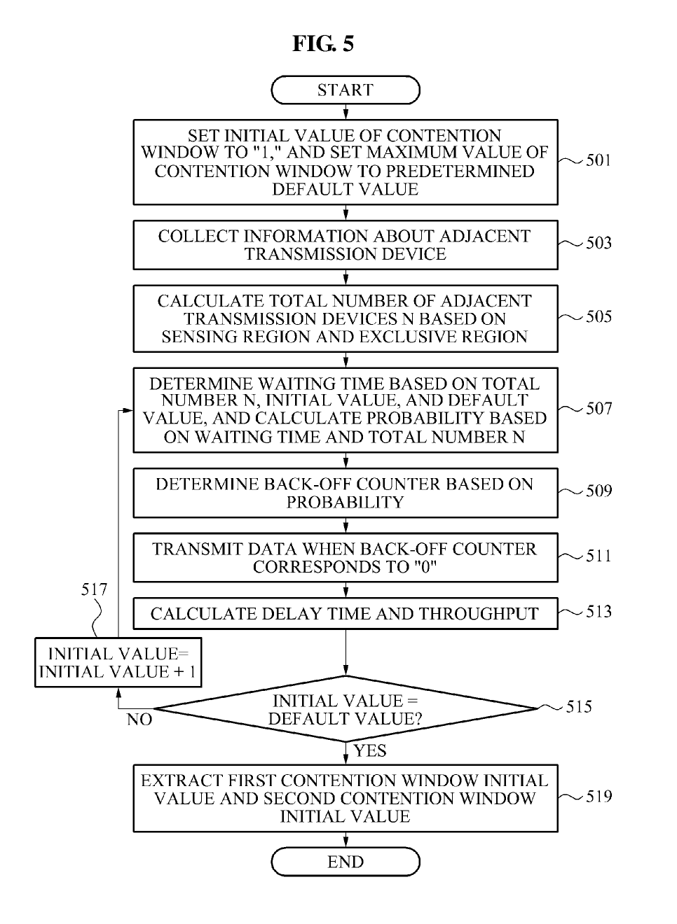

FIG. 5 is a flowchart illustrating a method for multiple accesses based on a resource contention using a directional antenna according to embodiments of the present invention.

In operation 501, an apparatus for multiple accesses based on a resource contention using a directional antenna may set an initial value CWᵢₙᵢ of a contention window to “1,” and may set a maximum value CWₘₐₓ of the contention window to a predetermined default value.

In operation 503, the apparatus for multiple accesses based on a resource contention using a directional antenna may collect information about adjacent transmission devices affecting a resource contention using neighbor discovery information and information from a piconet coordinator.

In operation 505, the apparatus for multiple accesses based on a resource contention using a directional antenna may calculate a total number of adjacent transmission devices N affecting the target transmission device and the target reception device based on a sensing region and an exclusive region. Information about the sensing region and the exclusive region may be included in information about the adjacent transmission devices. The apparatus for multiple accesses based on a resource contention using a directional antenna may calculate the total number N based on the information about the adjacent transmission devices.

In operation 507, the apparatus for multiple accesses based on a resource contention using a directional antenna may determine a waiting time W₀ for data transmission based on the total number N, an initial value CWᵢₙᵢ of a contention window updated according to a predetermined requirement, and a maximum value CWₘₐₓ of the contention window. The predetermined requirement may correspond to a case in which the initial value CWᵢₙᵢ of a contention window is not equal to the predetermined default value. The initial value CWᵢₙᵢ of the contention window may increase by “1” when the initial value CWᵢₙᵢ is not equal to the predetermined default value.

Here, the waiting time W₀ may correspond to a size of the contention window. The size of the contention window may be determined based on the total number N, the initial value CWᵢₙᵢ of the contention window updated according to a predetermined requirement, and the maximum value CWₘₐₓ of the contention window.

The apparatus for multiple accesses based on a resource contention using a directional antenna may calculate a probability for determining a value of a back-off counter based on the waiting time W₀ and the total number N.

In operation 509, the apparatus for multiple accesses based on a resource contention using a directional antenna may determine the value of the back-off counter based on the probability for determining the value of the back-off counter.

The apparatus for multiple accesses based on a resource contention using a directional antenna may determine the value of the back-off counter according to a first probability α calculated based on the total number N or a second probability β calculated based on the predetermined default value applied for the target transmission device and the adjacent transmission devices randomly, in response to the predetermined default value being determined as the waiting time W₀.

In operation 511, the apparatus for multiple accesses based on a resource contention using a directional antenna may transmit data in response to the value of the back-off counter being determined to be “0.”

In operation 513, the apparatus for multiple accesses based on a resource contention using a directional antenna may calculate a throughput and a delay time used for transmitting data.

In operation 515, the apparatus for multiple accesses based on a resource contention using a directional antenna may determine whether the initial value CWᵢₙᵢ of the contention window is equal to the predetermined default value after the throughput and the delay time are calculated.

In operation 517, the apparatus for multiple accesses based on a resource contention using a directional antenna may increase the initial value CWᵢₙᵢ of the contention window by “1” when the initial value CWᵢₙᵢ is not equal to the predetermined default value.

An initial value of a changed contention window may correspond to a reference for determining a new waiting time. In response to an initial value being changed, a probability for determining the waiting time and the back-off counter may change. Thus, a changed delay time and throughput may be calculated.

In operation 519, the apparatus for multiple accesses based on a resource contention using a directional antenna may extract a first contention window initial value corresponding to a minimum delay time in the delay time and a second contention window initial value corresponding to a maximum throughput when the initial value of the contention window has a predetermined default value.

The apparatus for multiple accesses based on a resource contention using a directional antenna may set the first contention window initial value or the second contention window initial value to a time period for waiting before transmitting data. The apparatus for multiple accesses based on a resource contention using a directional antenna may determine the first contention window initial value as an optimized contention window corresponding to the minimum delay time, and may determine the second contention window initial value as an optimized contention window corresponding to the maximum throughput.

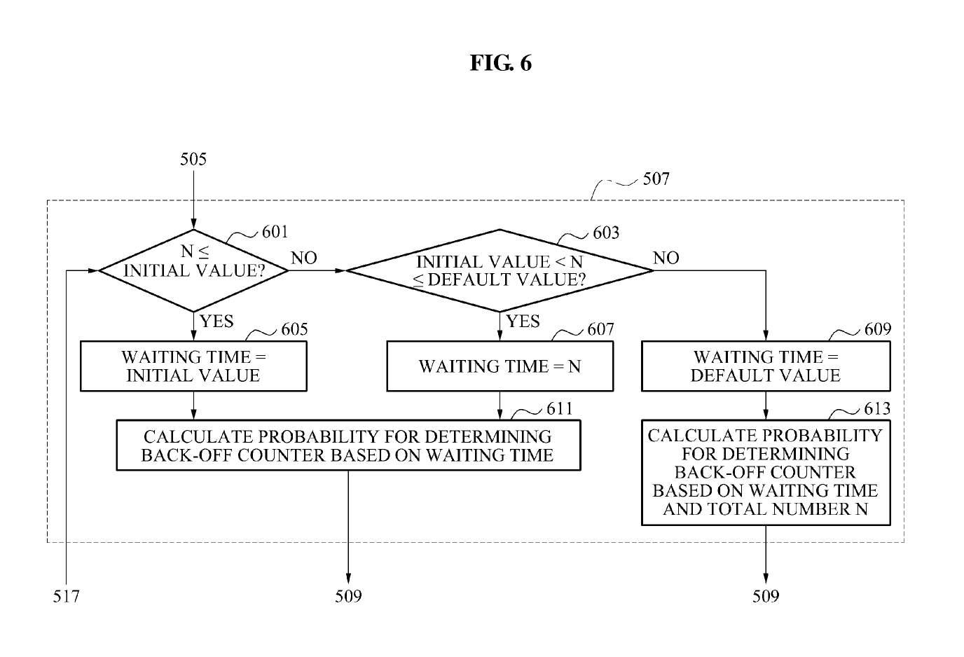

FIG. 6 is a flowchart illustrating a method of determining a waiting time and a probability for determining a value of a back-off counter corresponding to operation 507 of FIG. 5.

In operation 601, an apparatus for multiple accesses based on a resource contention using a directional antenna may determine whether a total number of adjacent transmission devices N affecting a target transmission device and a target reception device is less than or equal to an initial value CWᵢₙᵢ of a contention window based on information about adjacent transmission devices.

In operation 603, the apparatus for multiple accesses based on a resource contention using a directional antenna may determine whether the total number N is greater than the initial value CWᵢₙᵢ of the contention window and less than or equal to a predetermined default value.

In operation 605, the apparatus for multiple accesses based on a resource contention using a directional antenna may determine the initial value CWᵢₙᵢ of the contention window as a waiting time W₀ when the total number N is less than or equal to the initial value CWᵢₙᵢ of the contention window.

In operation 607, the apparatus for multiple accesses based on a resource contention using a directional antenna may determine the total number N to be the waiting time W₀ when the total number N is greater than the initial value CWᵢₙᵢ of the contention window and less than or equal to the predetermined default value.

In operation 609, the apparatus for multiple accesses based on a resource contention using a directional antenna may determine the predetermined default value as the waiting time W₀ when the total number N is greater than the predetermined default value.

In operation 611, the apparatus for multiple accesses based on a resource contention using a directional antenna may calculate the probability for determining the value of the back-off counter based on the initial value CWᵢₙᵢ of the contention window in response to the waiting time W₀ being determined to be the initial value CWᵢₙᵢ of the contention window. In particular, the apparatus for multiple accesses based on a resource contention using a directional antenna may calculate the probability for determining the value of the back-off counter to be 1/(CWᵢₙᵢ).

The apparatus for multiple accesses based on a resource contention using a directional antenna may calculate the probability for determining the value of the back-off counter based on the total number N in response to the waiting time W₀ being determined to be the total number N. In particular, the probability calculator 150 may calculate the probability for determining the value of the back-off counter to be 1/(N).

In operation 613, the apparatus for multiple accesses based on a resource contention using a directional antenna may calculate the probability for determining the value of the back-off counter based on the total number N and the predetermined default value in response to the waiting time W₀ being determined to be the predetermined default value. In particular, the apparatus for multiple accesses based on a resource contention using a directional antenna may calculate a first probability α to be 1/(N) and a second probability β to be 1-(W₀−1)/(N) that may be applied for the target transmission device and adjacent transmission devices randomly.

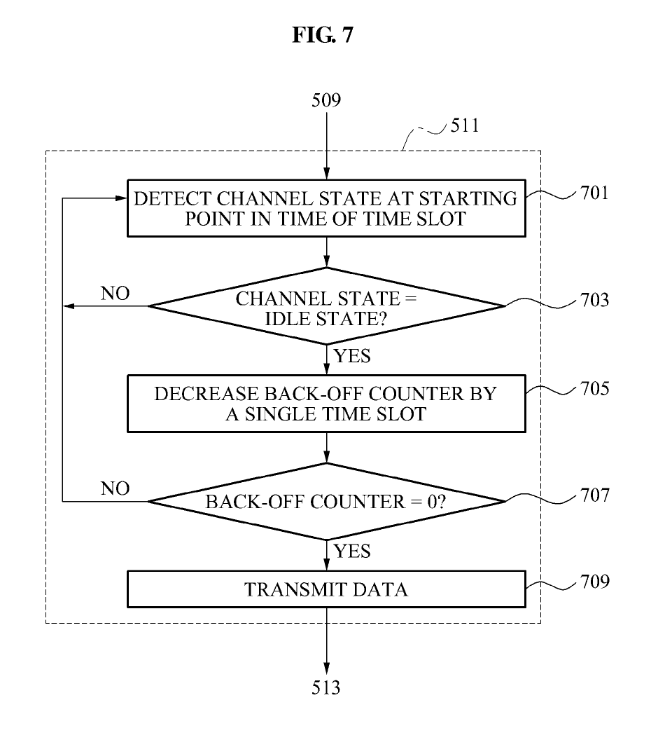

FIG. 7 is a flowchart illustrating a method of transmitting data corresponding to operation 511 of FIG. 5.

In operation 701, an apparatus for multiple accesses based on a resource contention using a directional antenna may detect a channel state for each starting point in time of a time slot corresponding to a back-off counter. That is, the apparatus for multiple accesses based on a resource contention using a directional antenna may detect the channel state at a starting point in time of the back-off counter determined according to a probability for determining the back-off counter.

The apparatus for multiple accesses based on a resource contention using a directional antenna may detect a channel state at predetermined intervals. The apparatus for multiple accesses based on a resource contention using a directional antenna may detect a channel state at a starting point in time of the time slot of the back-off counter when a value of the back-off counter does not correspond to “0.”

In operation 703, the apparatus for multiple accesses based on a resource contention using a directional antenna may detect whether the channel state is in an idle state.

In operation 705, the apparatus for multiple accesses based on a resource contention using a directional antenna may reduce the back-off counter by a single time slot in response to detection of the channel state as an idle state. When the channel state is determined to be in a busy state, the apparatus for multiple accesses based on a resource contention using a directional antenna may maintain the time slot of the back-off counter.

In operation 707, the apparatus for multiple accesses based on a resource contention using a directional antenna may control the back-off counter based on the channel state, and may determine whether the value of the back-off counter corresponds to “0.”

In operation 709, the apparatus for multiple accesses based on a resource contention using a directional antenna may transmit data in response to the value of the back-off counter becoming “0.”

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa. Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for multiple accesses based on a resource contention using a directional antenna in the resource contention of a wireless network using the directional antenna, the apparatus comprising:
a probability calculator to determine a waiting time for a data transmission based on a total number of adjacent transmission devices N affecting a target transmission device and a target reception device, an initial value of a contention window updated according to a predetermined requirement, and a maximum value of the contention window, and to calculate a probability for determining a value of a back-off counter based on the waiting time and the total number N;
a back-off counter determining unit to determine the value of the back-off counter based on the probability;
a data transmitter to control the back-off counter based on a channel state, and to transmit data in response to a value of the back-off counter becoming “0”; and
a maximum throughput and minimum delay time calculator to calculate a throughput and a delay time used for transmitting the data, and to extract a first contention window initial value corresponding to a minimum delay time in the delay time and a second contention window initial value corresponding to a maximum throughput in the throughput when the initial value of the contention window has a predetermined default value.

2. The apparatus of claim 1, further comprising:
a setting unit to set the initial value of the contention window to “1,” and to set the maximum value of the contention window to the predetermined default value;
an information collector to collect information about the adjacent transmission devices affecting the resource contention using neighbor discovery information and information from a piconet coordinator;
an area determining unit to determine a sensing region and an exclusive region based on the information about the adjacent transmission devices; and
a calculator to calculate the total number N based on the sensing region and the exclusive region.

3. The apparatus of claim 2, wherein:
the sensing region corresponds to a region for sensing a data transmission of a first transmission device when observed from the target transmission device, and
the exclusive region corresponds to a region for receiving data from the target transmission device by not sensing a data transmission of a second transmission device when observed from the target reception device.

4. The apparatus of claim 2, wherein the area determining unit determines the sensing region and the exclusive region
based on a distance between the target transmission device and the target reception device calculated using an antenna gain of the target transmission device, an antenna gain of the target reception device, a constant according to a propagation distance, a path loss exponent determined by a propagation environment, and transmission power of the target transmission device, and
based on locations of the target transmission device, the target reception device, and the adjacent transmission devices.

5. The apparatus of claim 1, wherein the probability calculator comprises a waiting time determining unit to determine, as the waiting time,
the initial value when the total number N is less than or equal to the initial value of the contention window,
the total number N when the total number N is greater than the initial value and is less than or equal to the predetermined default value, and
the predetermined default value when the total number N is greater than the predetermined default value.

6. The apparatus of claim 5, wherein the probability calculator calculates
a probability for determining the value of the back-off counter based on the initial value in response to the initial value being determined as the waiting time,
a probability for determining the value of the back-off counter based on the total number N in response to the total number N being determined as the waiting time, and
a probability for determining the value of the back-off counter based on the total number N and the predetermined default value in response to the predetermined default value determined as the waiting time.

7. The apparatus of claim 5, wherein the back-off counter determining unit determines the value of the back-off counter according to a first probability calculated based on the total number N or a second probability calculated based on the predetermined default value randomly applied for the target transmission device and the adjacent transmission devices in response to the predetermined default value being determined as the waiting time.

8. The apparatus of claim 1, wherein the data transmitter
detects the channel state for each starting point in time of a time slot corresponding to the back-off counter, and
reduces the back-off counter by a single time slot in response to detection of the channel state as an idle state.

9. The apparatus of claim 1, wherein the maximum throughput and minimum delay time calculator increases the initial value of the contention window by “1” until the initial value reaches the predetermined default value each time the delay time and the throughput are calculated.

10. The apparatus of claim 1, wherein the maximum throughput and minimum delay time calculator calculates
the delay time based on a time interval from point in time of traffic occurring before transmitting of the traffic starts, and based on a point in time at which transmitting of the traffic is completed, and
the throughput based on a first time interval used for transmitting the traffic and an amount of traffic transmitted during the first time interval.

11. A method for multiple accesses based on a resource contention using a directional antenna in the resource contention of a wireless network using the directional antenna, the method comprising:
setting an initial value of a contention window to “1,” and setting a maximum value of the contention window to a predetermined default value;
calculating a total number of adjacent transmission devices N affecting a target transmission device and a target reception device based on a sensing region and an exclusive region;
determining a waiting time for a data transmission based on the total number N, the initial value of the contention window updated according to a predetermined requirement, and a maximum value of the contention window;
calculating a probability for determining a value of a back-off counter based on the waiting time and the total number N;
determining the value of the back-off counter based on the probability;
detecting a channel state for each starting point in time of a time slot corresponding to the back-off counter;
controlling the back-off counter based on the channel state, and transmitting data in response to a value of the back-off counter becoming “0”;
calculating a throughput and a delay time used for transmitting the data; and
extracting a first contention window initial value corresponding to a minimum delay time in the delay time and a second contention window initial value corresponding to a maximum throughput in the throughput when the initial value of the contention window has the predetermined default value.

12. The method of claim 11, further comprising:
collecting information about the adjacent transmission devices affecting the resource contention using neighbor discovery information and information from a piconet coordinator; and
determining the sensing region and the exclusive region based on the information about the adjacent transmission devices.

13. The method of claim 11, wherein the determining of the waiting time comprises determining, as the waiting time,
the initial value when the total number N is less than or equal to the initial value of the contention window,
the total number N when the total number N is greater than the initial value and is less than or equal to the predetermined default value, and
the predetermined default value when the total number N is greater than the predetermined default value.

14. The method of claim 11, wherein the transmitting comprises reducing the back-off counter by a single time slot in response to detection of the channel state as an idle state.

15. The method of claim 11, further comprising:
determining whether the initial value of the contention window has the same value as the predetermined default value after calculating the delay time and the throughput; and
increasing the initial value of the contention window by “1” when the initial value of the contention window is not equal to the predetermined default value.
